(19) United States
(12) Patent Application Publication
(10) Pub. No.: US 2025/0274773 A1
(43) Pub. Date: Aug. 28, 2025

(54) APPARATUS, METHOD AND COMPUTER PROGRAM FOR SELECTION OF SIDELINK RESOURCES BETWEEN DIFFERENT RATS

(71) Applicant: Nokia Technologies Oy, Espoo (FI)

(72) Inventors: Vinh VAN PHAN, Oulu (FI); Nuno Manuel KIILERICH PRATAS, Aalborg (DK); Daniel MEDINA, Munich (DE); Torsten WILDSCHEK, Gloucester (GB); Faranaz SABOURI-SICHANI, Aalbong (DK); Ling YU, Espoo (FI); Jari Olavi LINDHOLM, Espoo (FI); Thomas Haaning JACOBSEN, Aalborg (DK)

(21) Appl. No.: 18/858,597

(22) PCT Filed: Mar. 17, 2023
(86) PCT No.: PCT/EP2023/056841

§ 371 Date: Oct. 21, 2024

Related U.S. Application Data
(60) Provisional application No. 63/336,045, filed on Apr. 28, 2022.

(51) Int. Cl. H04W 16/14; H04W 4/44; H04W 72/044; H04W 72/25; H04W 92/18

(52) U.S. Cl. CPC H04W 16/14; H04W 4/44; H04W 72/044; H04W 72/25; H04W 92/18

(57) ABSTRACT

There is provided an apparatus comprising at least one processor and at least one memory storing instructions that, when executed by the at least one processor, cause the apparatus, that is capable to perform sidelink, SL, transmissions according to a second radio access technology, RAT, over resources shared with SL transmissions according to a first RAT, at least to determine whether to perform SL sensing according to the first RAT over at least said shared resources prior to resource selection from said shared resources for SL transmissions according to the second RAT, the SL sensing according to the first RAT comprising decoding SL control information, SCI according to the first RAT.

### FIELD

The present application relates to a method, apparatus, system and computer program and in particular but not exclusively to enabling flexible sharing of radio resources for coexistence of LTE and NR SL-based V2X.

### BACKGROUND

A communication system can be seen as a facility that enables communication sessions between two or more entities such as user terminals, base stations and/or other nodes by providing carriers between the various entities involved in the communications path. A communication system can be provided for example by means of a communication network and one or more compatible communication devices. The communication sessions may comprise, for example, communication of data for carrying communications such as voice, video, electronic mail (email), text message, multimedia and/or content data and so on. Non-limiting examples of services provided comprise two-way or multi-way calls, data communication or multimedia services and access to a data network system, such as the Internet.

In a wireless communication system at least a part of a communication session between at least two stations occurs over a wireless link. Examples of wireless systems comprise public land mobile networks (PLMN), satellite based communication systems and different wireless local networks, for example wireless local area networks (WLAN). Some wireless systems can be divided into cells, and are therefore often referred to as cellular systems.

A user can access the communication system by means of an appropriate communication device or terminal. A communication device of a user may be referred to as user equipment (UE) or user device. A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

The communication system and associated devices typically operate in accordance with a given standard or specification which sets out what the various entities associated with the system are permitted to do and how that should be achieved. Communication protocols and/or parameters which shall be used for the connection are also typically defined. One example of a communications system is UTRAN (3G radio). Other examples of communication systems are the long-term evolution (LTE) of the Universal Mobile Telecommunications System (UMTS) radio-access technology and so-called 5G or New Radio (NR) networks. NR is being standardized by the 3rd Generation Partnership Project (3GPP).

### SUMMARY

In a first aspect there is provided an apparatus comprising at least one processor and at least one memory storing instructions that, when executed by the at least one processor, cause the apparatus, that is capable to perform sidelink, SL, transmissions according to a second radio access technology, RAT, over resources shared with SL transmissions according to a first RAT, at least to determine whether to perform SL sensing according to the first RAT over at least said shared resources prior to resource selection from said shared resources for SL transmissions according to the second RAT, the SL sensing according to the first RAT comprising decoding SL control information, SCI according to the first RAT;
upon determining to perform SL sensing according to the first RAT, perform SL sensing according to the first RAT over at least said shared resources, and based on the SL sensing according to the first RAT, select resources for SL transmissions according to the second RAT based on a scheduling unit of the first RAT, the scheduling unit of the first RAT having a dimension at least twice the dimension of a scheduling unit of the second RAT, wherein scheduling units of the second RAT in a first part of the scheduling units of the first RAT have priority for selection;
upon determining not to perform SL sensing according to the first RAT, perform SL sensing according to the second RAT over at least said shared resources, the SL sensing according to the second RAT comprising decoding SCI according to the second RAT, and based on the SL sensing according to the second RAT, select resources for SL transmissions according to the second RAT based on scheduling units of the second RAT, wherein scheduling units of the second RAT in a second part of scheduling units of the first RAT have priority for selection and perform SL transmission according to the second RAT using the selected resources.

The resources shared with SL transmissions according to the first RAT may be time-aligned with the resources for SL transmissions according to the second RAT.

The apparatus may be further caused to determine whether to perform the SL sensing according to the first RAT based on whether the apparatus is capable of performing SL sensing according to the first RAT.

The apparatus may be further caused to determine whether to perform the SL sensing according to the first RAT based on a configuration from a network.

Scheduling units of the second RAT in the second part of the scheduling units of the first RAT selected by at least one other UE performing SL transmissions according to the second RAT may have priority for selection by the apparatus not performing the SL sensing according to the first RAT.

Resources selected by the apparatus performing the SL sensing according to the first RAT based on the scheduling unit of the first RAT may comprise resources of the whole scheduling units of the first RAT.

Upon determining to perform the SL sensing according to the first RAT, the apparatus may be caused to perform the SL sensing according to the second RAT and select resources for SL transmissions according to the second RAT further based on the SL sensing according to the second RAT, wherein scheduling units of the first RAT with SL transmission according to the second RAT in the second part have priority for selection.

Upon determining to perform the SL sensing according to the first RAT, the apparatus may be further caused to provide SCI according to the first RAT to at least one further user equipment, wherein the SCI comprises an indication indicative that at least one scheduling unit of the first RAT has been selected for SL transmissions.

The SCI according to the first RAT may be sent upon SL transmission according to the second RAT based on the selected resources or may be sent prior to SL transmission according to the second RAT.

The SCI according to the first RAT may comprise an indication that it is provided from a second RAT capable user equipment.

The apparatus may be further caused to provide SCI according to the second RAT, wherein the SCI according to the second RAT comprises at least one of an indication of whether SCI according to the first RAT comprising the indication indicative that resources using the scheduling unit of the first RAT have been selected for SL transmissions according to the second RAT has been provided to at least one further user equipment, an indication of the selected resources based on the scheduling unit of the first RAT, an indication of the selected resources based on the scheduling unit of the second RAT, an indication of whether a user equipment according to the first RAT is in proximity, and an indication of load caused by the first RAT using the shared resources.

Upon determining not to perform SL sensing according to the first RAT, the apparatus may be further caused to receive SCI according to the second RAT, the SCI according to the second RAT comprising at least one of an indication of whether SCI according to the first RAT comprising the indication indicative that resources using the scheduling unit of the first RAT have been selected for SL transmissions according to the second RAT has been provided to at least one further user equipment, an indication of the selected resources according to the scheduling unit of the first RAT, an indication of the selected resources according to the scheduling unit of the second RAT, an indication of whether a user equipment according to the first RAT is in proximity and an indication of load caused by the first RAT using the shared resources.

The apparatus may be further caused to prioritise resources for selection based on the SCI.

Upon determining not to perform SL sensing according to the first RAT, the apparatus may be further caused to determine at least one of whether a SL transmission according to the first RAT is in proximity and an indication of load caused by the first RAT using the shared resources and select resources for SL transmissions according to the second RAT based on the determination.

The apparatus may be further caused to perform the SL sensing according to the first RAT using parameters for performing the SL sensing according to the second RAT.

The first RAT may be long term evolution, LTE. The second RAT may be new radio, NR.

The SL transmission may be vehicle-to-everything, V2X, transmission.

In a second aspect there is provided a method comprising at an apparatus that is capable to perform sidelink, SL, transmissions according to a second radio access technology, RAT, over resources shared with SL transmissions according to a first RAT determining whether to perform SL sensing according to the first RAT over at least said shared resources prior to resource selection from said shared resources for SL transmissions according to the second RAT, the SL sensing according to the first RAT comprising decoding SL control information, SCI according to the first RAT;
upon determining to perform SL sensing according to the first RAT, performing SL sensing according to the first RAT over at least said shared resources, and based on the SL sensing according to the first RAT, selecting resources for SL transmissions according to the second RAT based on a scheduling unit of the first RAT, the scheduling unit of the first RAT having a dimension at least twice the dimension of a scheduling unit of the second RAT, wherein scheduling units of the second RAT in a first part of the scheduling units of the first RAT have priority for selection;
upon determining not to perform SL sensing according to the first RAT, performing SL sensing according to the second RAT over at least said shared resources, the SL sensing according to the second RAT comprising decoding SCI according to the second RAT, and based on the SL sensing according to the second RAT, selecting resources for SL transmissions according to the second RAT based on scheduling units of the second RAT, wherein scheduling units of the second RAT in a second part of scheduling units of the first RAT have priority for selection and performing SL transmission according to the second RAT using the selected resources.

The resources shared with SL transmissions according to the first RAT may be time-aligned with the resources for SL transmissions according to the second RAT.

The method may comprise determining whether to perform the SL sensing according to the first RAT based on whether the apparatus is capable of performing SL sensing according to the first RAT.

The method may comprise determining whether to perform the SL sensing according to the first RAT based on a configuration from a network.

Scheduling units of the second RAT in the second part of the scheduling units of the first RAT selected by at least one other UE performing SL transmissions according to the second RAT may have priority for selection by the apparatus not performing the SL sensing according to the first RAT.

Resources selected by the apparatus performing the SL sensing according to the first RAT based on the scheduling unit of the first RAT may comprise resources of the whole scheduling units of the first RAT.

Upon determining to perform the SL sensing according to the first RAT, the method may comprise performing the SL sensing according to the second RAT and selecting resources for SL transmissions according to the second RAT further based on the SL sensing according to the second RAT, wherein scheduling units of the first RAT with SL transmission according to the second RAT in the second part have priority for selection.

Upon determining to perform the SL sensing according to the first RAT, the method may comprise providing SCI according to the first RAT to at least one further user equipment, wherein the SCI comprises an indication indicative that at least one scheduling unit of the first RAT has been selected for SL transmissions.

The SCI according to the first RAT may be sent upon SL transmission according to the second RAT based on the selected resources or may be sent prior to SL transmission according to the second RAT.

The SCI according to the first RAT may comprise an indication that it is provided from a second RAT capable user equipment.

The method may comprise providing SCI according to the second RAT, wherein the SCI according to the second RAT comprises at least one of an indication of whether SCI according to the first RAT comprising the indication indicative that resources using the scheduling unit of the first RAT have been selected for SL transmissions according to the second RAT has been provided to at least one further user equipment, an indication of the selected resources based on the scheduling unit of the first RAT, an indication of the selected resources based on the scheduling unit of the second RAT, an indication of whether a user equipment according to the first RAT is in proximity, and an indication of load caused by the first RAT using the shared resources.

Upon determining not to perform SL sensing according to the first RAT, the method may comprise receiving SCI according to the second RAT, the SCI according to the second RAT comprising at least one of an indication of whether SCI according to the first RAT comprising the indication indicative that resources using the scheduling unit of the first RAT have been selected for SL transmissions according to the second RAT has been provided to at least one further user equipment, an indication of the selected resources according to the scheduling unit of the first RAT, an indication of the selected resources according to the scheduling unit of the second RAT, an indication of whether a user equipment according to the first RAT is in proximity and an indication of load caused by the first RAT using the shared resources.

The method may comprise prioritising resources for selection based on the SCI.

Upon determining not to perform SL sensing according to the first RAT, the method may comprise determining at least one of whether a SL transmission according to the first RAT is in proximity and an indication of load caused by the first RAT using the shared resources and select resources for SL transmissions according to the second RAT based on the determination.

The method may comprise performing the SL sensing according to the first RAT using parameters for performing the SL sensing according to the second RAT.

The first RAT may be long term evolution, LTE. The second RAT may be new radio, NR.

The SL transmission may be vehicle-to-everything, V2X, transmission.

In a third aspect there is provided an apparatus that is capable to perform sidelink, SL, transmissions according to a second radio access technology, RAT, over resources shared with SL transmissions according to a first RAT comprising means for: determining whether to perform SL sensing according to the first RAT over at least said shared resources prior to resource selection from said shared resources for SL transmissions according to the second RAT, the SL sensing according to the first RAT comprising decoding SL control information, SCI according to the first RAT;
upon determining to perform SL sensing according to the first RAT, performing SL sensing according to the first RAT over at least said shared resources, and based on the SL sensing according to the first RAT, selecting resources for SL transmissions according to the second RAT based on a scheduling unit of the first RAT, the scheduling unit of the first RAT having a dimension at least twice the dimension of a scheduling unit of the second RAT, wherein scheduling units of the second RAT in a first part of the scheduling units of the first RAT have priority for selection;
upon determining not to perform SL sensing according to the first RAT, performing SL sensing according to the second RAT over at least said shared resources, the SL sensing according to the second RAT comprising decoding SCI according to the second RAT, and based on the SL sensing according to the second RAT, selecting resources for SL transmissions according to the second RAT based on scheduling units of the second RAT, wherein scheduling units of the second RAT in a second part of scheduling units of the first RAT have priority for selection and performing SL transmission according to the second RAT using the selected resources.

The resources shared with SL transmissions according to the first RAT may be time-aligned with the resources for SL transmissions according to the second RAT.

The apparatus may comprise means for determining whether to perform the SL sensing according to the first RAT based on whether the apparatus is capable of performing SL sensing according to the first RAT.

The apparatus may comprise means for determining whether to perform the SL sensing according to the first RAT based on a configuration from a network.

Scheduling units of the second RAT in the second part of the scheduling units of the first RAT selected by at least one other UE performing SL transmissions according to the second RAT may have priority for selection by the apparatus not performing the SL sensing according to the first RAT.

Resources selected by the apparatus performing the SL sensing according to the first RAT based on the scheduling unit of the first RAT may comprise resources of the whole scheduling units of the first RAT.

Upon determining to perform the SL sensing according to the first RAT, the apparatus may comprise means for performing the SL sensing according to the second RAT and selecting resources for SL transmissions according to the second RAT further based on the SL sensing according to the second RAT, wherein scheduling units of the first RAT with SL transmission according to the second RAT in the second part have priority for selection.

Upon determining to perform the SL sensing according to the first RAT, the apparatus may comprise means for providing SCI according to the first RAT to at least one further user equipment, wherein the SCI comprises an indication indicative that at least one scheduling unit of the first RAT has been selected for SL transmissions.

The SCI according to the first RAT may be sent upon SL transmission according to the second RAT based on the selected resources or may be sent prior to SL transmission according to the second RAT.

The SCI according to the first RAT may comprise an indication that it is provided from a second RAT capable user equipment.

The apparatus may comprise means for providing SCI according to the second RAT, wherein the SCI according to the second RAT comprises at least one of an indication of whether SCI according to the first RAT comprising the indication indicative that resources using the scheduling unit of the first RAT have been selected for SL transmissions according to the second RAT has been provided to at least one further user equipment, an indication of the selected resources based on the scheduling unit of the first RAT, an indication of the selected resources based on the scheduling unit of the second RAT, an indication of whether a user equipment according to the first RAT is in proximity, and an indication of load caused by the first RAT using the shared resources.

Upon determining not to perform SL sensing according to the first RAT, the apparatus may comprise means for receiving SCI according to the second RAT, the SCI according to the second RAT comprising at least one of an indication of whether SCI according to the first RAT comprising the indication indicative that resources using the scheduling unit of the first RAT have been selected for SL transmissions according to the second RAT has been provided to at least one further user equipment, an indication of the selected resources according to the scheduling unit of the first RAT, an indication of the selected resources according to the scheduling unit of the second RAT, an indication of whether a user equipment according to the first RAT is in proximity and an indication of load caused by the first RAT using the shared resources.

The apparatus may comprise means for prioritising resources for selection based on the SCI.

Upon determining not to perform SL sensing according to the first RAT, the apparatus may comprise means for determining at least one of whether a SL transmission according to the first RAT is in proximity and an indication of load caused by the first RAT using the shared resources and select resources for SL transmissions according to the second RAT based on the determination.

The apparatus may comprise means for performing the SL sensing according to the first RAT using parameters for performing the SL sensing according to the second RAT.

The first RAT may be long term evolution, LTE. The second RAT may be new radio, NR.

The SL transmission may be vehicle-to-everything, V2X, transmission.

In a fourth aspect there is provided a computer readable medium comprising program instructions for causing an apparatus that is capable to perform sidelink, SL, transmissions according to a second radio access technology, RAT, over resources shared with SL transmissions according to a first RAT to perform at least the following
upon determining to perform SL sensing according to the first RAT, performing SL sensing according to the first RAT over at least said shared resources, and based on the SL sensing according to the first RAT, selecting resources for SL transmissions according to the second RAT based on a scheduling unit of the first RAT, the scheduling unit of the first RAT having a dimension at least twice the dimension of a scheduling unit of the second RAT, wherein scheduling units of the second RAT in a first part of the scheduling units of the first RAT have priority for selection;
upon determining not to perform SL sensing according to the first RAT, performing SL sensing according to the second RAT over at least said shared resources, the SL sensing according to the second RAT comprising decoding SCI according to the second RAT, and based on the SL sensing according to the second RAT, selecting resources for SL transmissions according to the second RAT based on scheduling units of the second RAT, wherein scheduling units of the second RAT in a second part of scheduling units of the first RAT have priority for selection and performing SL transmission according to the second RAT using the selected resources.

The resources shared with SL transmissions according to the first RAT may be time-aligned with the resources for SL transmissions according to the second RAT.

The apparatus may be caused to perform determining whether to perform the SL sensing according to the first RAT based on whether the apparatus is capable of performing SL sensing according to the first RAT.

The apparatus may be caused to perform determining whether to perform the SL sensing according to the first RAT based on a configuration from a network.

Scheduling units of the second RAT in the second part of the scheduling units of the first RAT selected by at least one other UE performing SL transmissions according to the second RAT may have priority for selection by the apparatus not performing the SL sensing according to the first RAT.

Resources selected by the apparatus performing the SL sensing according to the first RAT based on the scheduling unit of the first RAT may comprise resources of the whole scheduling units of the first RAT.

Upon determining to perform the SL sensing according to the first RAT, the apparatus may be caused to perform performing the SL sensing according to the second RAT and selecting resources for SL transmissions according to the second RAT further based on the SL sensing according to the second RAT, wherein scheduling units of the first RAT with SL transmission according to the second RAT in the second part have priority for selection.

Upon determining to perform the SL sensing according to the first RAT, the apparatus may be caused to perform providing SCI according to the first RAT to at least one further user equipment, wherein the SCI comprises an indication indicative that at least one scheduling unit of the first RAT has been selected for SL transmissions.

The SCI according to the first RAT may be sent upon SL transmission according to the second RAT based on the selected resources or may be sent prior to SL transmission according to the second RAT.

The SCI according to the first RAT may comprise an indication that it is provided from a second RAT capable user equipment.

The apparatus may be caused to perform providing SCI according to the second RAT, wherein the SCI according to the second RAT comprises at least one of an indication of whether SCI according to the first RAT comprising the indication indicative that resources using the scheduling unit of the first RAT have been selected for SL transmissions according to the second RAT has been provided to at least one further user equipment, an indication of the selected resources based on the scheduling unit of the first RAT, an indication of the selected resources based on the scheduling unit of the second RAT, an indication of whether a user equipment according to the first RAT is in proximity, and an indication of load caused by the first RAT using the shared resources.

Upon determining not to perform SL sensing according to the first RAT, the apparatus may be caused to perform receiving SCI according to the second RAT, the SCI according to the second RAT comprising at least one of an indication of whether SCI according to the first RAT comprising the indication indicative that resources using the scheduling unit of the first RAT have been selected for SL transmissions according to the second RAT has been provided to at least one further user equipment, an indication of the selected resources according to the scheduling unit of the first RAT, an indication of the selected resources according to the scheduling unit of the second RAT, an indication of whether a user equipment according to the first RAT is in proximity and an indication of load caused by the first RAT using the shared resources.

The apparatus may be caused to perform prioritising resources for selection based on the SCI.

Upon determining not to perform SL sensing according to the first RAT, the apparatus may be caused to perform determining at least one of whether a SL transmission according to the first RAT is in proximity and an indication of load caused by the first RAT using the shared resources and select resources for SL transmissions according to the second RAT based on the determination.

The apparatus may be caused to perform performing the SL sensing according to the first RAT using parameters for performing the SL sensing according to the second RAT.

The first RAT may be long term evolution, LTE. The second RAT may be new radio, NR.

The SL transmission may be vehicle-to-everything, V2X, transmission.

In a fifth aspect there is provided a non-transitory computer readable medium comprising program instructions for causing an apparatus to perform at least the method according to the second aspect.

In the above, many different embodiments have been described. It should be appreciated that further embodiments may be provided by the combination of any two or more of the embodiments described above.

### DESCRIPTION OF FIGURES

Embodiments will now be described, by way of example only, with reference to the accompanying Figures in which:

FIG. 1 shows a schematic diagram of an example 5GS communication system;

FIG. 2 shows a schematic diagram of an example mobile communication device;

FIG. 3 shows a schematic diagram of an example control apparatus;

FIG. 4a shows a schematic diagram of LTE SL resource allocation mode 3;

FIG. 4b shows a schematic diagram of LTE SL resource allocation mode 4;

FIG. 5 shows a block diagram of LTE-V2X subframe slot format for PSSCH and PSCCH;

FIG. 6 shows a block diagram of LTE-V2X channelisation with adjacent and non-adjacent PSCCH and PSSCH;

FIG. 7a shows a schematic diagram of NR SL resource allocation mode 1;

FIG. 7b shows a schematic diagram of NR SL resource allocation mode 2;

FIG. 8a shows a block diagram of SL slot format with PSCCH/PSSCH;

FIG. 8b shows a block diagram of SL slot format with PSCCH/PSSCH and PSFCH;

FIG. 9 shows a table of PSSCH DMRS configurations based on the number of used symbols and duration of the PSCCH;

FIG. 10 shows a block diagram of SL slot with PSCCH/PSSCH and PSFCH;

FIG. 11 shows a block diagram of PSSCH to PSFCH mapping;

FIG. 12 shows time alignment between LTE SL and NR SL on the level of LTE subframe and NR slot;

FIG. 13 shows deployment band configuration for C-V2X at 5.9 GHZ in Europe;

FIG. 14a shows an example of LTE-V2X and NR-V2X co-channel FDM coexistence in the same carrier;

FIG. 14b shows an example of LTE-V2X and NR-V2X co-channel TDM coexistence in the same carrier;

FIG. 14c shows an example of LTE-V2X and NR-V2X co-channel mixed FDM and TDM coexistence in the same carrier;

FIG. 14d shows an example of LTE-V2X and NR-V2X co-channel coexistence in the same carrier in the same resources, where NR-V2X has additional dedicated resources;

FIG. 14e shows an example of LTE-V2X and NR-V2X co-channel coexistence in the same carrier in the same resources, where NR-V2X accesses the resources opportunistically;

FIG. 15 shows a flowchart of a method according to an example embodiment.

### DETAILED DESCRIPTION

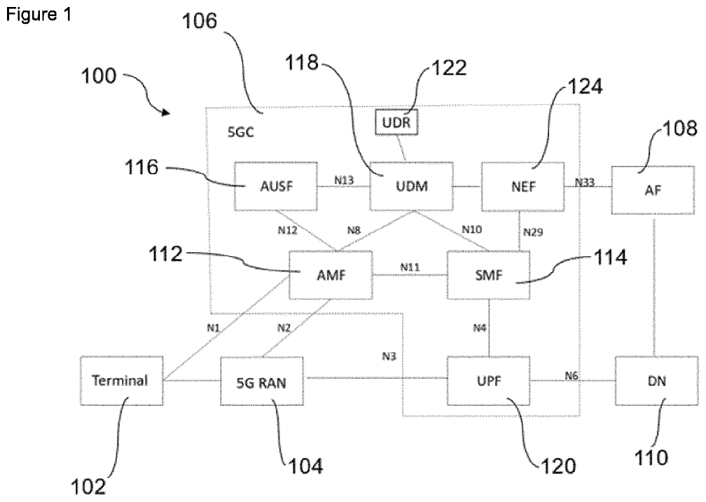

Before explaining in detail the examples, certain general principles of a wireless communication system and mobile communication devices are briefly explained with reference to FIGS. 1 to 3 to assist in understanding the technology underlying the described examples.

An example of a suitable communications system is the 5G System (5GS). Network architecture in 5GS may be similar to that of LTE-advanced. Base stations of NR systems may be known as next generation Node Bs (gNBs). Changes to the network architecture may depend on the need to support various radio technologies and finer QoS support, and some on-demand requirements for example QoS levels to support QoE of user point of view. Also network aware services and applications, and service and application aware networks may bring changes to the architecture. Those are related to Information Centric Network (ICN) and User-Centric Content Delivery Network (UC-CDN) approaches. NR may use multiple input-multiple output (MIMO) antennas, many more base stations or nodes than the LTE (a so-called small cell concept), including macro sites operating in co-operation with smaller stations and perhaps also employing a variety of radio technologies for better coverage and enhanced data rates.

5G networks may utilise network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations to be carried out, at least partly, in a server, host or node operationally coupled to a remote radio head. It is also possible that node operations will be distributed among a plurality of servers, nodes or hosts. It should also be understood that the distribution of labour between core network operations and base station operations may differ from that of the LTE or even be non-existent.

FIG. 1 shows a schematic representation of a 5G system (5GS) 100. The 5GS may comprise a user equipment (UE) 102 (which may also be referred to as a communication device or a terminal), a 5G radio access network (5GRAN) 104, a 5G core network (5GCN) 106, one or more application functions (AF) 108 and one or more data networks (DN) 110.

An example 5G core network (CN) comprises functional entities. The 5GCN 106 may comprise one or more access and mobility management functions (AMF) 112, one or more session management functions (SMF) 114, an authentication server function (AUSF) 116, a unified data management (UDM) 118, one or more user plane functions (UPF) 120, a unified data repository (UDR) 122 and/or a network exposure function (NEF) 124. The UPF is controlled by the SMF (Session Management Function) that receives policies from a PCF (Policy Control Function).

The CN is connected to a terminal device via the radio access network (RAN). The 5GRAN may comprise one or more gNodeB (GNB) distributed unit functions connected to one or more gNodeB (GNB) centralized unit functions. The RAN may comprise one or more access nodes.

A UPF (User Plane Function) whose role is called PSA (Protocol Data Unit (PDU) Session Anchor) may be responsible for forwarding frames back and forth between the DN (data network) and the tunnels established over the 5G towards the UE(s) exchanging traffic with the DN.

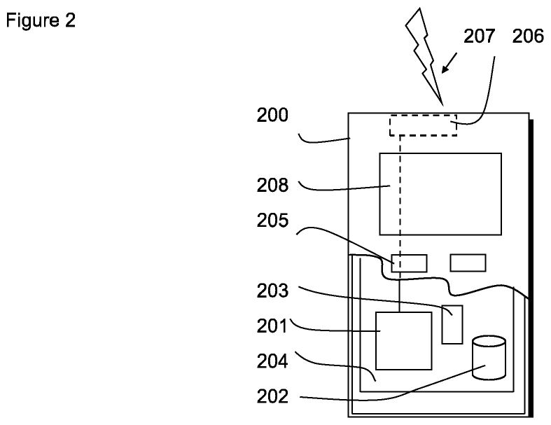

A possible mobile communication device will now be described in more detail with reference to FIG. 2 showing a schematic, partially sectioned view of a communication device 200. Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is known as a ‘smart phone’, a computer provided with a wireless interface card or other wireless interface facility (e.g., USB dongle), personal data assistant (PDA) or a tablet provided with wireless communication capabilities, voice over IP (VOIP) phones, portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), smart devices, wireless customer-premises equipment (CPE), or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

A mobile device is typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 204. The user may control the operation of the mobile device by means of a suitable user interface such as key pad 205, voice commands, touch sensitive screen or pad, combinations thereof or the like. A display 208, a speaker and a microphone can be also provided. Furthermore, a mobile communication device may comprise appropriate connectors (either wired or wireless) to other devices and/or for connecting external accessories, for example hands-free equipment, thereto.

The mobile device 200 may receive signals over an air or radio interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the mobile device.

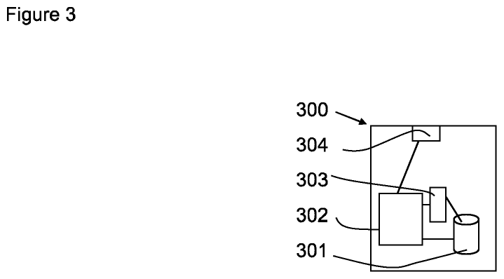

FIG. 3 shows an example of a control apparatus 300 for a communication system, for example to be coupled to and/or for controlling a station of an access system, such as a RAN node, e.g. a base station, eNB or gNB, a relay node or a core network node such as an MME or S-GW or P-GW, or a core network function such as AMF/SMF, or a server or host. The method may be implemented in a single control apparatus or across more than one control apparatus. The control apparatus may be integrated with or external to a node or module of a core network or RAN. In some embodiments, base stations comprise a separate control apparatus unit or module. In other embodiments, the control apparatus can be another network element such as a radio network controller or a spectrum controller. In some embodiments, each base station may have such a control apparatus as well as a control apparatus being provided in a radio network controller. The control apparatus 300 can be arranged to provide control on communications in the service area of the system. The control apparatus 300 comprises at least one memory 301, at least one data processing unit 302, 303 and an input/output interface 304. Via the interface the control apparatus can be coupled to a receiver and a transmitter of the base station. The receiver and/or the transmitter may be implemented as a radio front end or a remote radio head.

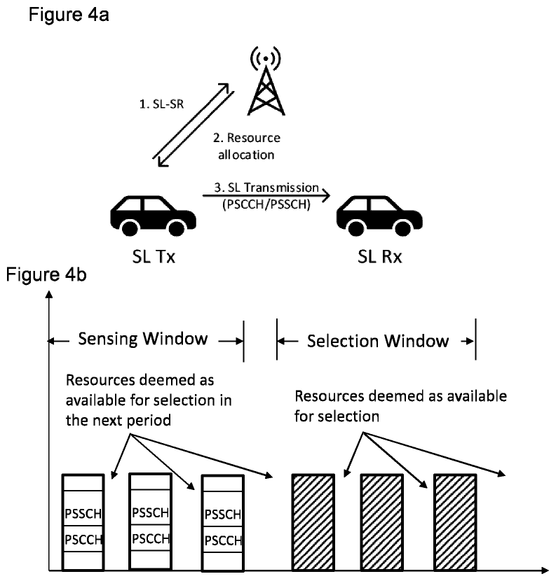

LTE-V2X has been designed to facilitate vehicles to communicate with other nearby vehicles via direct sidelink (SL) communication. Communications between these vehicles can take place in LTE-V2X using either mode 3 or mode 4, which are depicted in FIGS. 4a and 4b, respectively.

When in mode 3, the sidelink radio resources are scheduled by the base station or evolved NodeB (eNB), hence, mode 3 is only available when vehicles are under cellular coverage.

When in mode 4, the vehicles autonomously select their sidelink radio resources from one or more (pre-) configured resource pools regardless of whether they are under cellular coverage or not. The autonomous resource selection in mode 4 is performed using the sensing and resource exclusion procedure specified in Release 14, where a vehicle reserves the selected subchannel(s) for a number of periodically recurring packet transmissions. This in turn can be sensed by other vehicles, affecting their own resource selection/exclusion decisions.

When the vehicles are under cellular coverage, the network decides how to configure the LTE-V2X channel and informs the vehicles through the LTE-V2X configurable parameters. The message includes the carrier frequency of the LTE-V2X channel, the LTE-V2X resource pool, synchronization references, the channelization scheme, the number of subchannels per subframe, and the number of resource blocks (RBs) per subchannel, among others. When the vehicles are not under cellular coverage, they utilize a preconfigured set of parameters to replace the LTE-V2X configurable parameters. However, the standard does not specify a concrete value for each parameter. The LTE-V2X resource pool indicates which subframes of a channel are utilized for LTE-V2X. The rest of the subframes can be utilized by other services, including cellular communications.

LTE-V2X uses SC-FDMA (Single-Carrier Frequency-Division Multiple Access) and supports 10 MHz and 20 MHz channels. The channel is divided into 180 KHz Resource Blocks (RBs) that correspond to 12 subcarriers of 15 KHz each. In the time domain, the channel is organized into 1 ms subframes.

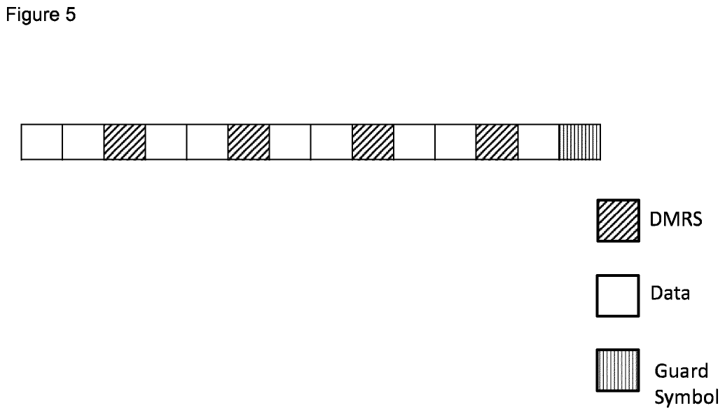

An example subframe format is illustrated in FIG. 5. Each subframe has 14 OFDM symbols with normal cyclic prefix. Nine of these symbols are used to transmit data and four of them (3rd, 6th, 9th, and 12th) are used to transmit demodulation reference signals (DMRSs) for channel estimation and combating the Doppler effect at high speeds. The last symbol is used as a guard symbol for timing adjustments and for allowing vehicles to switch between transmission and reception across subframes.

The RBs are grouped into sub-channels. A sub-channel can include RBs only within the same subframe. The number of RBs per sub-channel can vary and is (pre-) configured. Sub-channels are used to transmit data and control information. The data is organized in Transport Blocks (TBs) that are carried in the Physical Sidelink Shared Channel (PSSCH). A TB contains a full packet (e.g., a CAM or a BSM). A TB can occupy one or several subchannels depending on the size of the packet, the number of RBs per sub-channel, and the utilized Modulation and Coding Scheme (MCS). TBs can be transmitted using QPSK, 16-QAM or 64QAM modulations and turbo coding.

Each TB has an associated Sidelink Control Information (SCI) message that is carried in the Physical Sidelink Control Channel (PSCCH). It is also referred to as Scheduling Assignment (SA). An SCI occupies 2 RBs and includes information such as: an indication of the RBs occupied by the associated TB; the MCS used for the TB; the priority of the message that is being transmitted; an indication of whether it is a first transmission or a blind retransmission of the TB; and the resource reservation interval. A blind retransmission refers to a scheduled retransmission or repetition of the TB (i.e., not based on feedback from the receiver). The resource reservation interval specifies when the vehicle will utilize the reserved sub-channel(s) to transmit its next TB. The SCI includes critical information for the correct reception of the TB. A TB cannot be decoded properly if the associated SCI is not received correctly. A TB and its associated SCI must be transmitted always in the same subframe.

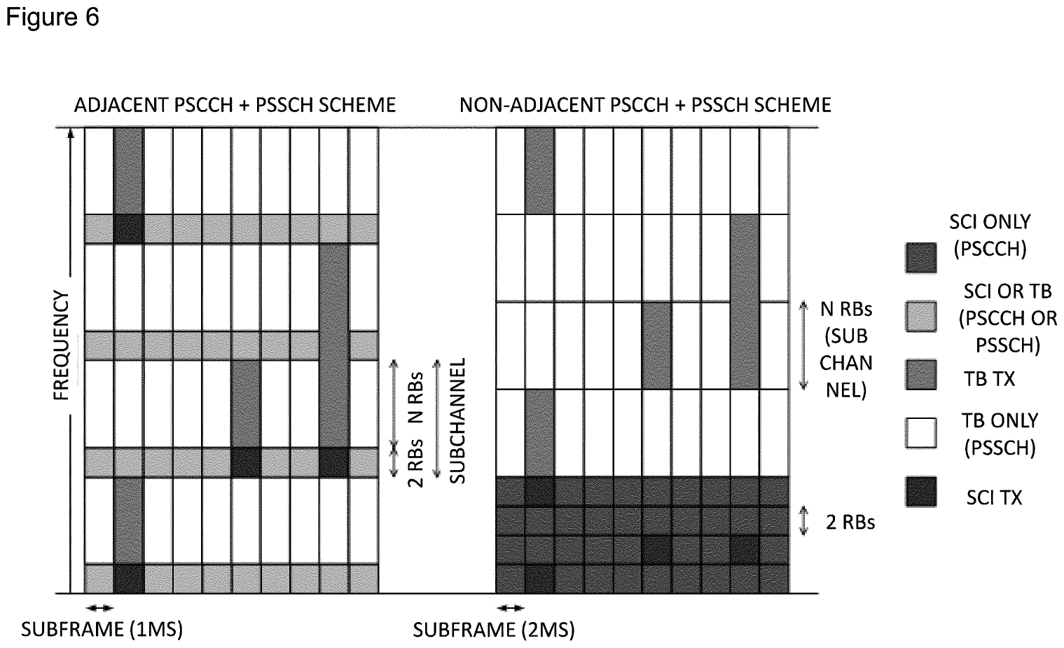

As depicted in FIG. 6, the TB (PSSCH) and its associated SCI (PSCCH) can be transmitted in adjacent or non-adjacent sub-channels.

For adjacent PSCCH+PSSCH, the SCI and TB are transmitted in adjacent RBs. For each SCI+TB transmission, the SCI occupies the first two RBs of the first subchannel utilized for the transmission. The TB is transmitted in the RBs following the SCI, and can occupy several subchannels (depending on its size). If it does so, it will also occupy the first two RBs of the following subchannels.

For nonadjacent PSCCH+PSSCH: The RBs are divided into pools. One pool is dedicated to transmit only SCIs, and the SCIs occupy two RBs. The second pool is reserved to transmit only TBs and is divided into subchannels.

NR sidelink (SL) has been designed to facilitate a user equipment (UE) to communicate with other nearby UE(s) via direct SL communication. Two resource allocation modes have been specified, and a SL transmitter (TX) UE is configured with one of them to perform its NR SL transmissions. These modes are denoted as NR SL mode 1 and NR SL mode 2. In mode 1, a sidelink transmission resource is assigned (scheduled) by the network (NW) to the SL TX UE, while a SL TX UE in mode 2 autonomously selects its SL transmission resources from one or more (pre-) configured resource pools.

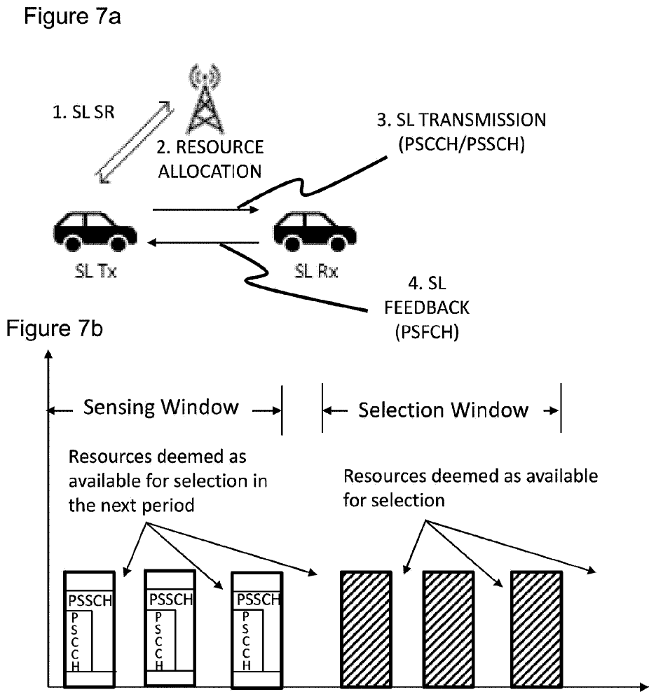

In mode 1, where the gNB is responsible for the SL resource allocation, the configuration and operation is similar to the one over the Uu interface (as depicted in FIG. 7a). The MAC level details of this procedure are specified in 3GPP standards.

In mode 2, as depicted in FIG. 7b, the SL UEs perform the resource selection autonomously with the aid of a sensing procedure. More specifically, a SL TX UE in NR SL mode 2 first performs a sensing procedure over the configured SL transmission resource pool(s), in order to obtain the knowledge of the reserved resource(s) by other nearby SL TX UE(s). Based on the knowledge obtained from sensing, the SL TX UE may select resource(s) from the available SL resources, accordingly. In order for a SL UE to perform sensing and obtain the necessary information to receive a SL transmission, it decodes the sidelink control information (SCI). In 3GPP release 16, the SCI associated with a data transmission includes a 1st-stage SCI and 2nd-stage SCI, and their contents are specified in 3GPP standards.

The SCI follows a 2-stage SCI structure, whose main motivation is to support the size difference between the SCIs for various NR-V2X SL service types (e.g., broadcast, groupcast and unicast).

The 1st-stage SCI, SCI format 1-A, carried by PSCCH and contains information to enable sensing operations and information needed to determine resource allocation of the PSSCH and to decode 2nd-stage SCI.

The 2nd-stage SCI, SCI format 2-A and 2-B, carried by PSSCH (multiplexed with SL-SCH) and contains source and destination identities, information to identify and decode the associated SL-SCH TB, control of HARQ feedback in unicast/groupcast and trigger for CSI feedback in unicast.

The configuration of the resources in the sidelink-reception resource pool defines the minimum information required for a RX UE to be able to decode a transmission, which includes the number of sub-channels, the number of PRBs per sub-channels, the number of symbols in the PSCCH, which slots have a PSFCH and other configuration.

However, the details of the actual sidelink transmission (i.e., the payload on PSCCH) are provided in the 1st-stage SCI for each individual transmission, which include the time and frequency resources, the DMRS configuration of the PSSCH, the MCS and PSFCH, among others.

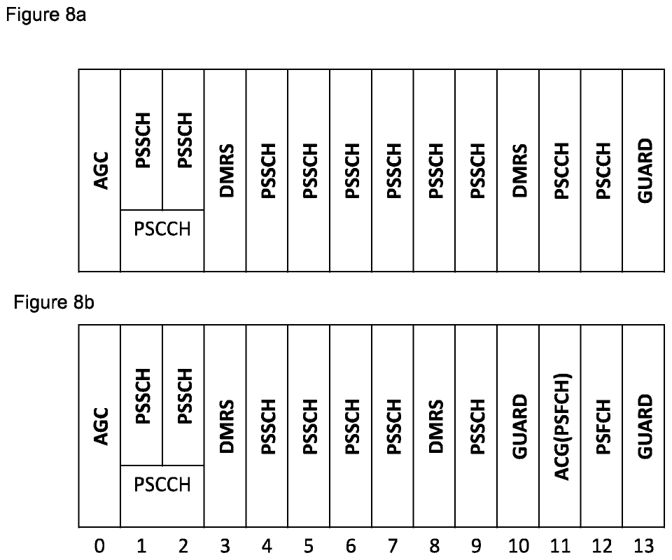

An example of the SL slot structure is depicted in FIG. 8a, which illustrates a slot with PSCCH/PSSCH and FIG. 8b which illustrates a slot with PSCCH/PSSCH where the last symbols are used for PSFCH.

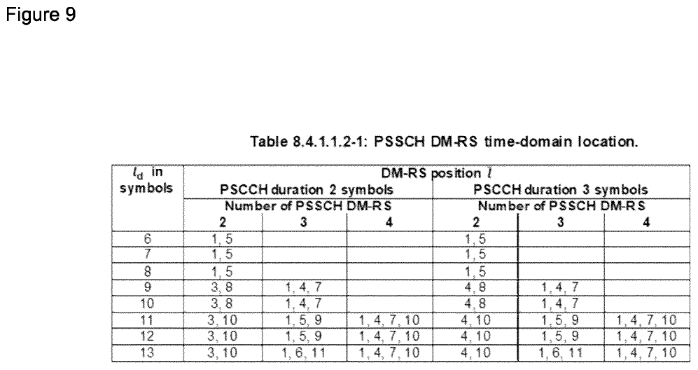

The configuration of the PSCCH (e.g., DMRS, MCS, number of symbols used) is part of the resource pool configuration. Furthermore, the indication of which slots have PSFCH symbols is also part of the resource pool configuration. However, the configuration of the PSSCH (e.g., the number of symbols used, the DMRS pattern and the MCS) is provided by the 1st-stage SCI which is the payload sent within the PSCCH and follows the configuration depicted in FIG. 9.

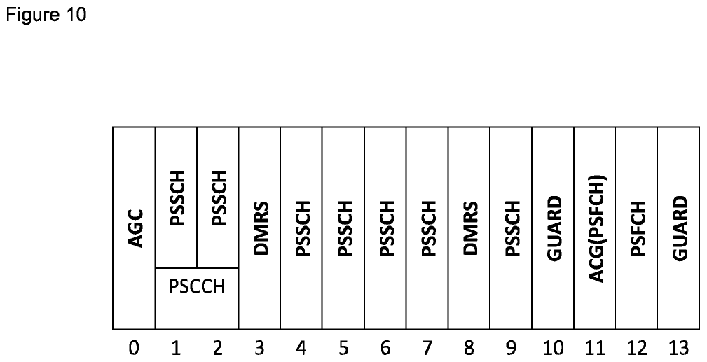

The PSFCH was introduced to enable HARQ feedback over the sidelink from a UE that is the intended recipient of a PSSCH transmission (i.e., the RX UE) to the UE that performed the transmission (i.e., the TX UE). Within a PSFCH, a Zadoff-Chu sequence in one physical resource block (PRB) is repeated over two OFDM symbols, the first of which can be used for AGC, near the end of the sidelink resource in a slot. An example slot format of PSCCH, PSSCH, and PSFCH is provided in FIG. 10. The Zadoff-Chu sequence as base sequence is (pre-) configured per sidelink resource pool.

The time resources for PSFCH are (pre-) configured to occur once every 1, 2, or 4 slots. The HARQ feedback resource (PSFCH) is derived from the resource location of PSCCH/PSSCH used for corresponding SL HARQ transmission of TB.

For PSSCH-to-HARQ timing, there is a configuration parameter K with the unit of slot. The time occasion for PSFCH is determined from K. For a PSSCH transmission with its last symbol in slot n, HARQ feedback is in slot n+a where a is the smallest integer larger than or equal to K with the condition that slot n+a contains PSFCH resources.

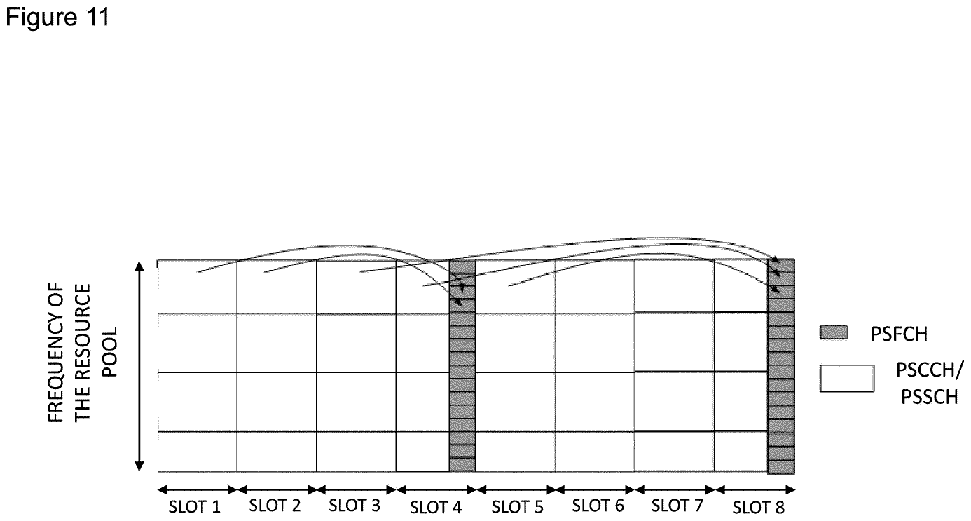

As an example illustrated in FIG. 11, the period of PSFCH resources is configured as 4, and K (the sl-MinTimeGapPSFCH) is configured as 3. For a PSSCH transmitted in slot 1 or 2, the time occasion for the corresponding PSFCH is slot 4. PSFCH resources used for HARQ feedback of PSSCH transmissions with the same starting sub-channel in different slots are FDM-ed. In the example shown in FIG. 11, PSFCH resources for PSSCHs in slot 1 and 2 are FDM-ed in slot 4.

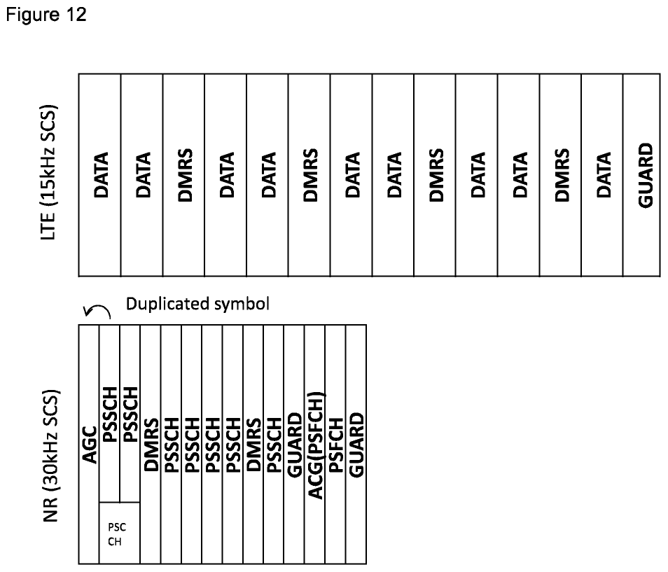

FIG. 12 illustrates time alignment between LTE SL and NR SL on the level of LTE subframe and NR slot. One LTE subframe is mapped on two NR slots.

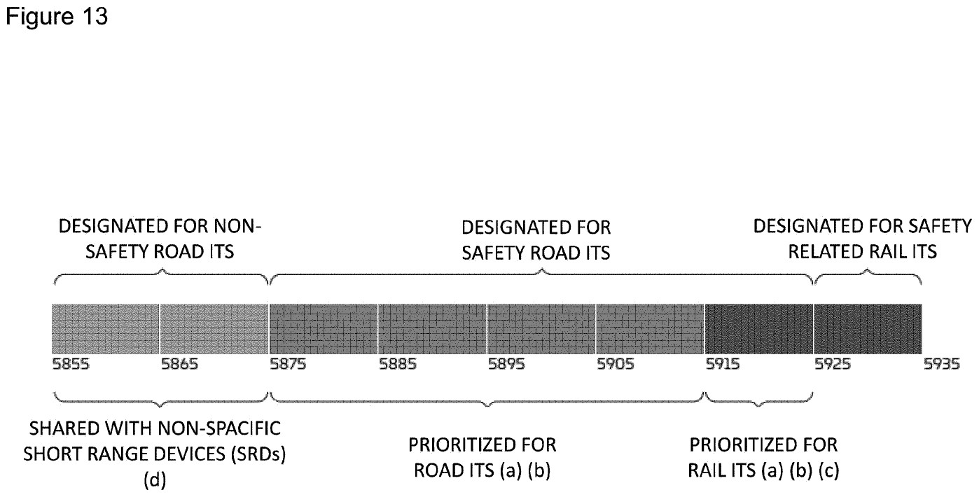

European administrations have designated the bands 5855-5875 MHz and 5875-5925 MHZ, referred to as the 5.9 GHz band, for use by road Intelligent Transport Systems (ITS). Industry is planning for the deployment of C-V2X (LTE-V2X and NR-V2X) technologies for direct communications (via the PC5 interface) in the 5.9 GHz band, as depicted in FIG. 13.

In this spectrum range, the following aspects should be considered. No harmful interference shall be caused to the application having priority. Road-ITS and rail-ITS shall remain confined to their respective prioritized frequency range until such time when appropriate spectrum sharing solutions are defined by ETSI. Vehicle-to-vehicle (V2V) communications for road-ITS may only be permitted at 5915-5925 MHz once spectrum sharing solutions for the protection of rail ITS have been developed at ETSI. In the absence of such sharing solutions for the protection of rail-ITS, national administrations may permit infrastructure-to-vehicle (12V) communications for road-ITS at 5915-5925 MHz subject to coordination with rail-ITS. Use of spectrum in the frequency range 5855-5875 MHz is on a non-interference/non-protected basis, and includes use by non-safety road-ITS and non-specific short range devices.

In the deployment band configuration proposed by 5GAA for C-V2X at 5.9 GHZ in Europe, LTE-V2X is constrained to the 5905-5915 MHz and 5915-5925 MHz bands. The remaining spectrum is expected to be made available to NR-V2X.

There are challenges associated with the impact of inter-technology coexistence on safety. Namely, there is an ongoing coexistence work item at ETSI to investigate the viability of co-channel coexistence between LTE-V2X and ITS-G5 in the 5.9 GHz band. Such co-existence may negatively impact the ability of the two technologies to deliver safe and reliable communications and may also impact the specifications of the technologies and the complexity of the products.

In a V2X deployment scenario where both LTE V2X and NR V2X devices are to coexist in the same frequency channel, for the two different types of devices to coexist while using a common carrier frequency, there should be a mechanism to efficiently utilize resource allocation by the two technologies without negatively impacting the operation of each technology.

An in-device coexistence framework for NR SL has been introduced.

For TDM based operation a Synchronization/subframe boundary alignment is needed between LTE and NR sidelink.

For long term time-scale TDM operation, LTE SL and NR SL resource pools are configured to not overlap in time domain, with no specification impact.

For short term time-scale TDM operation, for TX/TX and TX/RX overlap, if packet priorities of both LTE and NR sidelink transmissions/receptions are known to both RATs prior to time of transmission subject to processing time restriction, then the packet with a higher relative priority is transmitted/received. For equal priority TX/TX or TX/RX, the determination is up to UE implementation. For RX/RX case the determination is up to UE implementation.

The priority of PSFCH is the same as the corresponding PSSCH. The priorities of LTE PSBCH and NR S-SSB are (pre-) configured If multiple NR SL transmissions/receptions overlap with single LTE SL TX/RX, the highest priority NR SL TX/RX determines the priority of the NR SL.

For FDM based operation, there is static frequency allocation between NR and LTE SL. Synchronization is not needed between NR and LTE if frequency separation between LTE and NR is large enough. There is static power allocation, which implies that full UE TX power is used only when LTE and NR SL are transmitted simultaneously.

It would be desirable to go beyond in-device coexistence and focus on co-channel coexistence, i.e., the coexistence between different devices (UEs) in the same radio resources/carrier frequency.

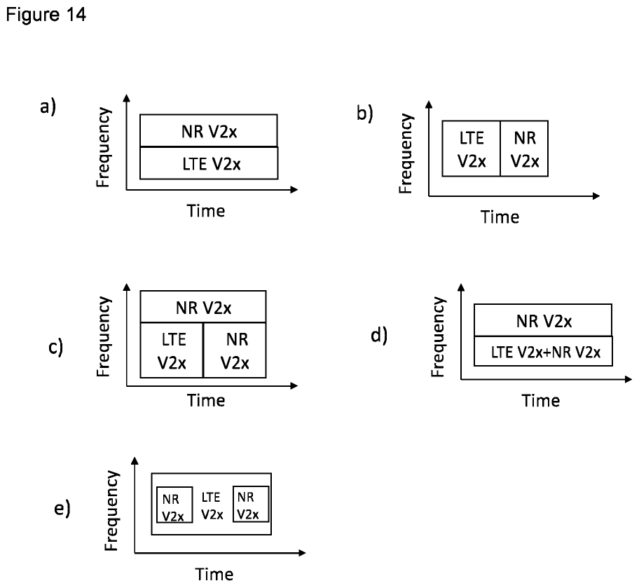

In FIG. 14, examples of coexistence of LTE-V2X and NR-V2X in the same radio resources are illustrated.

FIG. 14a shows FDM coexistence. FIG. 14b shows TDM coexistence. FIG. 14c shows mixed FDM and TDM coexistence. FIG. 14d shows Coexistence of LTE-V2X+NR-V2X in the same resources, where NR-V2X has additional dedicated resources. FIG. 14e shows coexistence of LTE-V2X+NR-V2X in the same resources, where NR-V2X accesses the resources opportunistically. From a resource use point of view, FIGS. 14(d) and (e) illustrate dynamic spectrum sharing, which may be more flexible and enable higher efficiency. However, these schemes have the drawback of being more complex due to the ancillary mechanisms that enable their coexistence with other systems. In contrast, static spectrum sharing options, as those depicted in FIGS. 14(a), (b) and (c), are simpler. It can also be anticipated that FIG. 14(e) may be the only available option in practice, as the LTE-V2X devices may be configured to occupy the entire bandwidth and NR-V2X devices will need to be able to adapt to that in order to be able to access the ITS band. However, considering potential difficulties to modify pre-configuration, it may be better to allow NR V2X UE use all the available resources, so that there are no dedicated resources for LTE (or NR) but the same resources are available for both i.e. complete overlap.

As no enhancement is expected from LTE-V2X point of view to enable this sharing, no change or reconfiguration may be expected to the resource pool configurations associated with the LTE-V2X device. Instead it is expected that all changes will be made from the NR-V2X device point of view, therefore dynamic spectrum sharing schemes are a solution for LTE-V2X and NR-V2X coexistence.

The more new vehicles are introduced into the market, the more critical it will become to support advanced V2X use cases that require NR-V2X to operate. At the same time, since CAM (or BSM) can be both sent using LTE-V2X or NR-V2X, then as we progress in time, it is expected that more and more vehicles will utilize NR-V2X and fewer vehicles LTE-V2X. Therefore, by enabling LTE-V2X and NR-V2X to coexist in the same resources, then this will enable a soft re-farming of the LTE-V2X resources. In contrast, if static TDM or FDM deployments are considered for LTE-V2X and NR-V2X, this will imply that the resources associated with LTE-V2X will remain allocated potentially for several decades without NR-V2X being able to use those resources.

For this solution, NR-V2X should be allowed for road-safety related ITS.

In the deployment scenario where NR-V2X devices are able to use the same resources (i.e., the example depicted in FIG. 14(d)), the NR-V2X numerology should be contained as far as possible within the LTE-V2X numerology. NR-V2X is expected to be deployed in FR1 with a sub-carrier spacing of 30 kHz, while LTE-V2X has a sub-carrier spacing of 15 kHz. Therefore, in the time-domain, two NR-V2X slots can be contained in one LTE-V2X subframe, while in the frequency domain, an NR-V2X PRB will have twice the bandwidth of an LTE-V2X PRB. Both LTE-V2X and NR-V2X SL resources are organized into resource pools, which in the time domain are organized into slots (NR-V2X) or subframes (LTE-V2X), while in the frequency domain these are organized into subchannels composed by a number of PRBs. The configurable number of PRBs for LTE-V2X and NR-V2X are as follows:
LTE-V2X: 4, 5, 6, 8, 9, 10, 12, 15, 16, 18, 20, 25, 30, 48, 50, 72, 75, 96, 100.
NR-V2X: 10, 12, 15, 20, 25, 50, 75, 100

Assuming a perfect overlap between an LTE-V2X resource pool and one (or more) NR-V2X resource pools, there may the pairing of configurations, as depicted in Table 1.

TABLE 1

| LTE-V2X subchannel | NR-V2X subchannel configurations |
|---|---|
| configuration | with perfect overlap |
| 20 | 10 |
| 30 | 15 |
| 48 | 12 |
| 50 | 25 |
| 75 | 25 |
| 100 | 50, 25 |

Table 1 shows an example of a fully overlapped NR-V2X resource pool into a LTE-V2X resource pool. In practice, as there will be multiple LTE-V2X resource pools, it is possible to achieve any number of LTE-V2X and NR-V2X resource pools. The important aspect is that the LTE-V2X and NR-V2X PRBs are aligned both in time and frequency.

As mentioned in the discussion associated with FIG. 14, a NR UE operating in NR mode 2 needs to be able to coexist in resources which have been configured as part of a resource pool (RP) for LTE UE in LTE mode 4 for coexistence of LTE and NR SL-based V2X. Both NR mode 2 and LTE mode 4 are autonomous resource allocation modes in which a UE is allowed to select and reserve resources from a configured RP for SL transmissions. LTE mode 4 for V2X is based on sensing or random selection, whereas NR mode 2 for V2X is more flexible, e.g., it is based on sensing or random selection, and with possible inter-UE coordination (IUC).

NR mode 2 may be further enhanced to support the coexistence of LTE and NR SL-based V2X, also referred to as the LTE-NR SL coexist. It is assumed that shared LTE and NR resources in the LTE-NR SL coexist are aligned in time on the basis of SL frame boundaries and thus LTE SL subframes and NR SL slots, as illustrated in FIG. 12. Thus, each LTE subframe is mapped on 2 NR slots, referred to as the 1st slot and 2nd slot considering LTE V2x is using SCS 15 kHz while NR V2x applies 30 KHz SCS.

It is desirable for the SL LTE-NR coexist that NR UE is able to perform resource selection and reservation on shared resources in such a way that is backward-compatible with LTE UE (i.e. in such a way that the impact of NR SL on a LTE SL transmission and reception is at the same level as another LTE SL transmission). One option is for NR SL UE to perform LTE SL specific sensing for its resource selection and reservation as well as to facilitate LTE SL specific sensing for other LTE UEs by announcing its resource selection and reservation to other LTE UEs in the LTE SCI over LTE PSCCH when transmitting NR PSCCH and PSSCH on selected resources. In this option, NR UE may have to select and reserve resources on the LTE subframe basis, even though it may need only a portion, e.g., half of the resources for NR SL transmission on the NR slot basis.

A challenge arises when the LTE-NR SL coexist needs to consider support for NR UE with different capabilities regarding transmitting or receiving LTE SL signals and therefore capable of performing LTE SL specific sensing or not. For example, a NR UE may be: incapable of both transmitting and receiving any LTE SL signals and therefore neither performing LTE SL specific sensing nor announcing LTE SCI to LTE UE; capable of receiving limited LTE SL signals such as LTE SCI; capable of transmitting limited LTE SL signals such as LTE SCI; capable of both transmitting and receiving limited LTE SL signals such as LTE SCI; or capable of both transmitting and receiving all LTE SL signals.

A UE capable of both transmitting and receiving all LTE SL signals may be a UE device operating as both LTE UE and NR UE in parallel. In this case there may be issues with in-device coexistence of LTE and NR as well if the same Tx-Rx chain is shared by both LTE UE and NR UE of the same UE device. However, it is assumed that NR UE, regardless of LTE transmitting and receiving capabilities, is at least capable of detecting in the first slot and refraining from using resources in the second slot of the corresponding LTE subframe that are used by LTE UE for NR PSCCH and PSSCH transmissions on the fly so as not to cause collision to LTE UE.

Thus, a flexible and practical scheme that guides a NR SL UE on how to perform resource selection and reservation is needed to enable and facilitate efficient LTE-NR SL coexist.

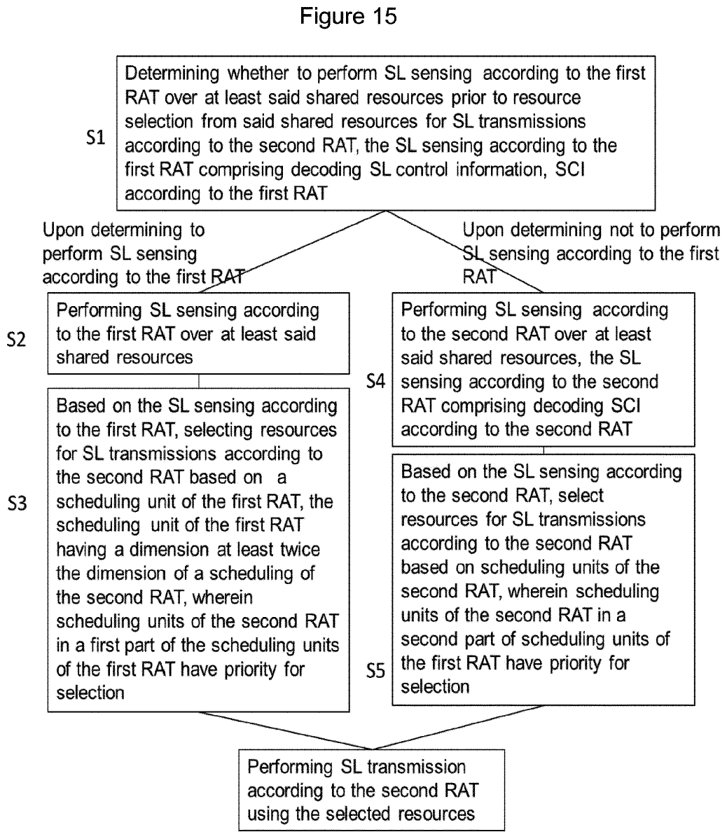

FIG. 15 shows a flowchart of a method according to an example embodiment. The method is performed at a user equipment that is capable to perform sidelink, SL, transmissions according to a second radio access technology, RAT, over resources shared with SL transmissions according to a first RAT.

In S1, the method comprises determining whether to perform SL sensing according to the first RAT over at least said shared resources prior to resource selection from said shared resources for SL transmissions according to the second RAT, the SL sensing according to the first RAT comprising decoding SL control information, SCI, according to the first RAT.

Upon determining to perform SL sensing according to the first RAT, in S2, the method comprises performing SL sensing according to the first RAT over at least said shared resources.

In S3, following S2, the method comprises, based on the SL sensing according to the first RAT, selecting resources for SL transmissions according to the second RAT based on a scheduling unit of the first RAT, the scheduling unit of the first RAT having a dimension at least twice the dimension of a scheduling unit of the second RAT, wherein scheduling units of the second RAT in a first part of the scheduling units of the first RAT have priority for selection.

Upon determining not to perform SL sensing according to the first RAT, in S4, the method comprises performing SL sensing according to the second RAT over at least said shared resources, the SL sensing according to the second RAT comprising decoding SCI according to the second RAT.

In S5, following S4, the method comprises, based on the SL sensing according to the second RAT, selecting resources for SL transmissions according to the second RAT based on scheduling units of the second RAT, wherein scheduling units of the second RAT in a second part of scheduling units of the first RAT have priority for selection.

Following S3, or S5, the method comprises performing SL transmission according to the second RAT using the selected resources in S6.

The first RAT may be LTE and the second RAT may be NR. The SL transmission may be V2x transmission.

The resources shared with SL transmissions according to the first RAT may be time-aligned with the resources for SL transmissions according to the second RAT

The method introduces conditions and restrictions on resource selection and reservation for a NR SL UE over the shared resources configured for the LTE-NR SL coexist in dependence on whether LTE SL specific sensing is performed by NR SL UE or not. The method may provide a flexible and cooperative scheme for resource selection and reservation among NR SL UEs in the LTE-NR SL coexist so as to allow NR SL UEs with different capabilities to share resources with LTE SL UEs effectively. In the following we use the terms NR UE to denote a NR SL UE, and LTE UE to denote a LTE SL UE.

Upon determining to perform the SL sensing according to the first RAT, the method may comprise providing SCI according to the first RAT (e.g., LTE SCI) to at least one further user equipment, wherein the SCI according to the first RAT comprises an indication indicative that at least one scheduling unit of the first RAT has been selected for SL transmissions. The SCI according to the first RAT may include an indication of the resources selected for SL transmissions.

For example, the NR UE announces its own resource selection and reservation to other LTE UEs via a NR UE transmitted LTE SCI.

The SCI according to the first RAT may be sent upon SL transmission according to the second RAT based on the selected resources.

The NR UE may transmit the LTE SCI to announce to LTE UE(s) the selected and reserved resources based on performing LTE SL specific sensing upon transmitting NR SL PSCCH and PSSCH on at least part of the selected and reserved resources (first slots of associated subframes).

The SCI according to the first RAT may be sent prior to SL transmission according to the second RAT.

For example, the transmission of the LTE SCI can occur by itself and precede the NR UE's NR PSCCH and PSSCH transmission so that the other LTE UEs sensing procedure can be affected in time. This in turn can introduce timing restrictions at the NR UE side in terms of timing of its initial resource selection, i.e., that the LTE SCI announcement is separated from the NR UE resource selection by at least an amount of time that reflects the ability of the other LTE UEs to react to it.

The SCI according to the first RAT may comprise an indication it is provided from a second RAT capable user equipment. It may be useful for the NR UE that is capable of performing LTE SL specific sensing to be able to differentiate resource selection and reservation of LTE UEs from that of NR UEs in the LTE-NR SL coexist. This may be applied for enhancing resource selection and reservation of the NR UE towards a flexible and fair sharing of resources in the LTE-NR SL coexist. For example, at least one reserved bit in LTE SCI (e.g., the last 32th bit) may be set to 1 to indicate that the LTE SCI is from a NR UE.

In an example embodiment, a NR UE performs LTE SL specific sensing for resource selection and reservation for its own NR SL transmissions.

Resources selected by the apparatus performing the SL sensing according to the first RAT based on the scheduling unit of the first RAT may comprise resources of the whole scheduling units of the first RAT.

For example, the NR UE may select and reserve resources on LTE subframes for SL transmissions without predefined restrictions. In addition, the NR UE may be configured to select and reserve resources for its own transmission in certain LTE subframes and also reserve the rest of the resources of the same LTE subframe for other NR UE(s). In this case, NR UE indicates in LTE SCI that the whole LTE subframes in frequency domain are reserved.

Alternatively or additionally, the NR UE may be configured to prioritize selecting and reserving resources in the first slot of corresponding LTE subframes for its own NR SL transmissions. This implies that the second slot of corresponding LTE subframes is left for other NR UEs which do not need to perform LTE SL specific sensing but NR SL specific sensing to use, as proposed below. If NR UE reserves and announces the whole LTE subframes in LTE SCI, the unused resources by the NR UE in the first slot are also left for other NR UEs.

Upon determining to perform the SL sensing according to the first RAT, the method may comprise performing the SL sensing according to the second RAT and selecting resources for SL transmissions according to the second RAT further based on the SL sensing according to the second RAT, wherein scheduling units of the first RAT with SL transmission according to the second RAT in the second part have priority for selection. For example, if the NR UE performs LTE SL specific sensing for resource selection and reservation, the NR UE may prioritize to select and reserve LTE subframes in which other NR UEs (which are not capable of performing LTE SL specific sensing) have resource reservations.

If the NR UE does not announce resource selection and reservation to other LTE UEs via a NR UE transmitted LTE SCI, the NR UE may select and reserve resources on LTE subframes, restricted for periodic SL transmissions compatible with LTE periodicities so that the energy based sensing supported in LTE SL mode 4 can be reused to avoid resource selection conflict between NR UEs and LTE UEs.

The NR UE may be configured to prioritize selecting and reserving resources in the first slot of corresponding LTE subframes for NR SL transmissions. This can help NR UEs without LTE SL specific sensing capability to select the rest of slots of corresponding LTE subframes.

Scheduling units of the second RAT in the second part of the scheduling units of the first RAT selected by at least one other UE performing SL transmissions according to the second RAT may have priority for selection by the apparatus not performing the SL sensing according to the first RAT

When the apparatus determines not to perform SL sensing according to the first RAT, the NR UE may be configured to select and reserve resources in first slots of corresponding LTE subframes based on performing NR SL specific sensing if another NR UE indicates it reserved and announced the whole corresponding LTE subframes in frequency domain to other LTE UEs using LTE SCI. In other words, the NR UE is configured to select and reserve NR SL resources in corresponding LTE subframes, when it senses that other NR SL UE(s) has (have) reserved the corresponding LTE SL subframes and resources in first slots therein are still available.

The method may comprise providing SCI according to the second RAT (e.g., NR SCI), wherein the SCI according to the second RAT comprises at least one of an indication of whether SCI according to the first RAT comprising the indication indicative that resources using the scheduling unit of the first RAT have been selected for SL transmissions according to the second RAT has been provided to at least one further user equipment, an indication of the selected resources based on the scheduling unit of the first RAT, and an indication of the selected resources based on the scheduling unit of the second RAT.

Upon determining not to perform SL sensing according to the first RAT, the method may comprise receiving the SCI according to the second RAT. The method may comprise prioritizing resources for selection based on the received SCI.

For example, the NR SCI may be enhanced to indicate whether the reserved resources are announced to LTE UEs or not as well as whether the whole LTE subframe in frequency domain is reserved and announced to LTE UEs or only the actual reserved resources for NR SL transmission are announced to LTE UEs.

Upon receiving the proposed indication of reserving and announcing the whole LTE subframe and normal resource reservation information in NR SCI, the NR UE prioritizes selection and reservation of remaining resources in first slots of corresponding LTE subframes left by other NR UE that sends the NR SCI with the proposed indication.

The NR UE may avoid pre-empting reserved resources of other NR UE that indicates in the NR SCI it announced the reserved resources to LTE UEs using LTE SCI.

In an example embodiment, when the apparatus determines not to perform SL sensing according to the first RAT, the NR UE is configured to select and reserve resources in second slots of corresponding LTE subframes based on performing NR SL specific sensing.

In an example embodiment, if another NR UE indicates the whole LTE subframe has been reserved and announced to LTE UE, the NR UE prioritizes selection and reservation of resources in second slots of LTE subframes that the other UE has announced to LTE UE.

In an example embodiment, if another NR UE indicates only the actual reserved resources to LTE UE, the NR UE prioritizes selection and reservation of resources in second slots corresponding to the resources in frequency domain reserved by other NR UE in first slots of corresponding LTE subframes.

If another NR UE indicates the whole LTE subframe is reserved and announced to LTE UE, the NR UE, optionally controlled by (pre) configuration, may not need to perform detection of ongoing LTE transmission in the first slot before transmitting NR PSCCH and PSSCH in the second slot of the same LTE subframe.

If another NR UE doesn't detect/sense NR SCI from other NR UE indicating to announce the reserved resources to LTE UE in the first slot of LTE subframe, the NR UE may select and reserve resources only in second slots of LTE subframe using normal NR SL sensing mechanism. In this case, the NR UE performs detection of ongoing LTE transmission in the first slot before transmitting NR PSCCH and PSSCH in the second slot of the same LTE subframe. For this reason, the NR UE may be allowed to reserve some back-up or secondary resources, e.g., in case the priority of SL transmissions, as set and indicated in NR SCI of the NR UE, is higher than a threshold.

Determining whether to perform SL sensing according to the first RAT may be based on whether the user equipment is capable of performing SL sensing according to the first RAT or on a configuration from a network

In one option, the NR UE that is capable of performing LTE SL specific sensing may be mandated by the serving network to perform LTE SL specific sensing for resource selection and reservation in the LTE-NR SL coexist. In another option, the NR UE that is capable of performing LTE SL specific sensing may be allowed to determine by itself whether to perform LTE SL specific sensing for resource selection and reservation in the LTE-NR SL coexist or not. In yet another option, the NR UE that is capable of performing LTE SL specific sensing may be configured to prioritize NR SL specific sensing for resource selection and reservation in order to utilize reserved resources in second slots of corresponding LTE subframes left by other NR UEs.

The method may comprise performing SL sensing according to the first RAT using parameters for performing SL sensing according to the second RAT. For example, the NR UE that is capable of performing LTE SL specific sensing may be allowed to apply NR compatible constraints of sensing and selection windows (much shorter compared to that of LTE) for performing LTE SL specific sensing for resource selection and reservation, e.g., in case the NR UE has an urgent need for one-off SL transmission (including possible retransmission).

Performing SL sensing according to the first RAT comprises decoding SCI according to the first RAT. A sensing result (set S_A) in LTE may be determined based on decoded SCI and additionally measured S-RSSI (energy sensing). (S-RSSI is also used to obtain CBR.) A NR UE may be unable to decode LTE SCI (and so not capable of performing SL sensing according to the first RAT), but may be able to measure S-RSSI.

Performing SL sensing according to the second RAT may comprise decoding SCI according to the second RAT.

SCI according to the second RAT may comprise at least one of an indication of whether a user equipment according to the first RAT is in proximity and an indication of load caused by SL transmissions according to the first RAT using the shared resources.

The NR UE that is capable of performing LTE SL specific sensing may be configured to monitor LTE offered load (i.e., traffic demand) and NR offered load over the shared resources, e.g., based on CBR measurement combined with SCI monitoring of both LTE and NR. The latter includes detection of whether NR UE is capable of performing LTE SL specific sensing or not based on the resource selection and reservation announced in at least one of LTE SCI and NR SCI of NR UE, as proposed above.

The NR UE that is capable of performing LTE SL specific sensing may be configured to perform the following when performing the resource selection and reservation using at least LTE SL specific sensing for a fair sharing of resources in the LTE-NR SL coexist:

To select and reserve resources of entire LTE subframes for itself and other NR UEs in case the NR UE monitors and detects at least one of: the number of NR UEs which are not capable of performing LTE SL specific sensing (as described in the previous paragraph for example) is above a threshold; the overall CBR on the shared resources is below a threshold; and the LTE load is above a threshold.

To set 3-bit priority in LTE SCI (the lower the value the higher the priority) when announcing the resource selection and reservation to LTE UEs as well as other NR UEs which are performing LTE SL specific sensing based on a preconfigured function of at least one of: the priority of its own SL transmissions; the amount and the use of selected and reserved resources for its own SL transmissions vs. the leftover for other NR UEs; the overall CBR as measured on the shared resources; the LTE offered load vs. the NR offered load as monitored on the shared resources.

For example, if the NR UE uses at least half of the selected and reserved resources, e.g., the resources in the first slots of corresponding LTE subframes, the NR UE may set the priority in LTE SCI the same as that in NR SCI.

If the NR UE uses less than half of the selected and reserved resources, e.g., when the NR UE selects and reserves resources of entire LTE subframes for itself and other NR UEs, the NR UE may set the priority in LTE SCI the same as that in NR SCI if the overall CBR is below a threshold or if the overall CBR is above a threshold and the LTE offered load is above a threshold, with a lower value than that in NR SCI if the overall CBR is below a threshold and the NR offered load is above a threshold or with a higher value than that in NR SCI if the overall CBR is above a threshold and the LTE offered load is below a threshold.

When the apparatus determines not to perform SL sensing according to the first RAT, the method may comprise determining at least one of whether a SL transmission according to the first RAT is in proximity and an indication of load caused by the first RAT using the shared resources and select resources for SL transmissions according to the second RAT based on the determination.

The priority setting in LTE SCI and NR SCI may be used for giving priority in resource sharing to either LTE UE or NR UE in general or for certain UE category or service class, as determined by the serving network.

An apparatus that is capable to perform sidelink, SL, transmissions according to a second radio access technology, RAT, over resources shared with SL transmissions according to a first RAT may comprise means for determining whether to perform SL sensing according to the first RAT over at least said shared resources prior to resource selection from said shared resources for SL transmissions according to the second RAT, the SL sensing according to the first RAT comprising decoding SL control information, SCI according to the first RAT;
upon determining to perform SL sensing according to the first RAT, performing SL sensing according to the first RAT over at least said shared resources, and based on the SL sensing according to the first RAT, selecting resources for SL transmissions according to the second RAT based on a scheduling unit of the first RAT, the scheduling unit of the first RAT having a dimension at least twice the dimension of a scheduling unit of the second RAT, wherein scheduling units of the second RAT in a first part of the scheduling units of the first RAT have priority for selection;
upon determining not to perform SL sensing according to the first RAT, performing SL sensing according to the second RAT over at least said shared resources, the SL sensing according to the second RAT comprising decoding SCI according to the second RAT, and based on the SL sensing according to the second RAT, selecting resources for SL transmissions according to the second RAT based on scheduling units of the second RAT, wherein scheduling units of the second RAT in a second part of scheduling units of the first RAT have priority for selection and performing SL transmission according to the second RAT using the selected resources.]

It should be understood that the apparatuses may comprise or be coupled to other units or modules etc., such as radio parts or radio heads, used in or for transmission and/or reception. Although the apparatuses have been described as one entity, different modules and memory may be implemented in one or more physical or logical entities.

It is noted that whilst some embodiments have been described in relation to 5G networks, similar principles can be applied in relation to other networks and communication systems. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

In general, the various embodiments may be implemented in hardware or special purpose circuitry, software, logic or any combination thereof. Some aspects of the disclosure may be implemented in hardware, while other aspects may be implemented in firmware or software which may be executed by a controller, microprocessor or other computing device, although the disclosure is not limited thereto. While various aspects of the disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The embodiments of this disclosure may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments of the disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The scope of protection sought for various embodiments of the disclosure is set out by the independent claims. The embodiments and features, if any, described in this specification that do not fall under the scope of the independent claims are to be interpreted as examples useful for understanding various embodiments of the disclosure.

The foregoing description has provided by way of non-limiting examples a full and informative description of the exemplary embodiment of this disclosure. However, various modifications and adaptations may become apparent to those skilled in the relevant arts in view of the foregoing description, when read in conjunction with the accompanying drawings and the appended claims. However, all such and similar modifications of the teachings of this disclosure will still fall within the scope of this invention as defined in the appended claims. Indeed, there is a further embodiment comprising a combination of one or more embodiments with any of the other embodiments previously discussed.

1-20. (canceled)

21. A user equipment comprising: at least one processor and at least one memory storing instructions that, when executed by the at least one processor, cause the user equipment, that is capable to perform sidelink (SL) transmissions according to a second radio access technology (RAT) over resources shared with SL transmissions according to a first RAT, at least to:
perform SL sensing according to the first RAT over at least said shared resources prior to resource selection from said shared resources for SL transmissions according to the second RAT, the SL sensing according to the first RAT comprising decoding SL control information (SCI) according to the first RAT, wherein the first RAT is long term evolution (LTE) and the second RAT is new radio (NR);
based on the SL sensing according to the first RAT, select resources for SL transmissions according to the second RAT based on a scheduling unit of the first RAT, the scheduling unit of the first RAT being a subframe and having a dimension at least twice a dimension of a scheduling unit of the second RAT, the scheduling unit of the second RAT being a slot, wherein scheduling units of the second RAT in a first part of the scheduling units of the first RAT have priority for selection; and
perform SL transmission according to the second RAT using the selected resources.

22. The user equipment according to claim 21, wherein the resources shared with SL transmissions according to the first RAT are time-aligned with the resources for SL transmissions according to the second RAT.

23. The user equipment according to claim 21, wherein resources selected by the apparatus performing the SL sensing according to the first RAT based on the scheduling unit of the first RAT comprise resources of the whole scheduling units of the first RAT.

24. The user equipment according to claim 21, wherein the user equipment is further caused to perform the SL sensing according to the second RAT and select resources for SL transmissions according to the second RAT further based on the SL sensing according to the second RAT, wherein scheduling units of the first RAT with SL transmission according to the second RAT in the second part of the scheduling units of the first RAT have priority for selection.

25. The user equipment according to claim 21, wherein the user equipment is further caused to provide SCI according to the first RAT to at least one further user equipment, wherein the SCI comprises an indication indicative that at least one scheduling unit of the first RAT has been selected for SL transmissions.

26. The user equipment according to claim 25, wherein the SCI according to the first RAT is sent upon SL transmission according to the second RAT based on the selected resources or wherein the SCI according to the first RAT is sent prior to SL transmission according to the second RAT.

27. The user equipment according to claim 25, wherein the SCI according to the first RAT comprises an indication that it is provided from a second RAT capable user equipment.

28. The user equipment according to claim 21, wherein the user equipment is further caused to determine whether to perform the SL sensing according to the first RAT.

29. The user equipment according to claim 28, wherein the determination of whether to perform the SL sensing according to the first RAT is based on at least one of the following: whether the user equipment is capable of performing SL sensing according to the first RAT, or a configuration from a network.

30. The user equipment according to claim 28, wherein, upon determining not to perform SL sensing according to the first RAT, perform SL sensing according to the second RAT over at least said shared resources, the SL sensing according to the second RAT comprising decoding SCI according to the second RAT, and based on the SL sensing according to the second RAT, select resources for SL transmissions according to the second RAT based on scheduling units of the second RAT, wherein scheduling units of the second RAT in a second part of scheduling units of the first RAT have priority for selection.

31. The user equipment according to claim 28, wherein, upon determining not to perform SL sensing according to the first RAT, the user equipment is further caused to receive SCI according to the second RAT, the SCI according to the second RAT comprising at least one of:
an indication of whether SCI according to the first RAT comprising the indication indicative that resources using the scheduling unit of the first RAT have been selected for SL transmissions according to the second RAT has been provided to at least one further user equipment,
an indication of the selected resources according to the scheduling unit of the first RAT,
an indication of the selected resources according to the scheduling unit of the second RAT,
an indication of whether a user equipment according to the first RAT is in proximity, and
an indication of load caused by the first RAT using the shared resources.

32. The user equipment according to claim 31, wherein the user equipment is further caused to prioritize resources for selection based on the SCI.

33. The user equipment according to claim 28, wherein upon determining not to perform SL sensing according to the first RAT, the user equipment is further caused to determine at least one of: whether a SL transmission according to the first RAT is in proximity or an indication of load caused by the first RAT using the shared resources, and select resources for SL transmissions according to the second RAT based on the determination.

34. The user equipment according to claim 21, wherein the user equipment is further caused to provide SCI according to the second RAT, wherein the SCI according to the second RAT comprises at least one of:
an indication of whether SCI according to the first RAT, which comprises the indication indicative that resources using the scheduling unit of the first RAT have been selected for SL transmissions according to the second RAT, has been provided to at least one further user equipment,
an indication of the selected resources based on the scheduling unit of the first RAT,
an indication of the selected resources based on the scheduling unit of the second RAT,
an indication of whether a user equipment according to the first RAT is in proximity, and
an indication of load caused by the first RAT using the shared resources.

35. The user equipment according to claim 21, wherein the SL transmission is vehicle-to-everything, V2X, transmission.

36. A method performed at a user equipment that is capable to perform sidelink (SL) transmissions according to a second radio access technology (RAT) over resources shared with SL transmissions according to a first RAT, the method comprising:
performing SL sensing according to the first RAT over at least said shared resources prior to resource selection from said shared resources for SL transmissions according to the second RAT, the SL sensing according to the first RAT comprising decoding SL control information (SCI) according to the first RAT, wherein the first RAT is long term evolution (LTE) and the second RAT is new radio (NR);
based on the SL sensing according to the first RAT, selecting resources for SL transmissions according to the second RAT based on a scheduling unit of the first RAT, the scheduling unit of the first RAT being a subframe and having a dimension at least twice a dimension of a scheduling unit of the second RAT, the scheduling unit of the second RAT being a slot, wherein scheduling units of the second RAT in a first part of the scheduling units of the first RAT have priority for selection; and
performing SL transmission according to the second RAT using the selected resources.

37. A non-transitory computer readable medium comprising program instructions for causing a user equipment that is capable to perform sidelink (SL) transmissions according to a second radio access technology (RAT) over resources shared with SL transmissions according to a first RAT to perform at least the following:
perform SL sensing according to the first RAT over at least said shared resources prior to resource selection from said shared resources for SL transmissions according to the second RAT, the SL sensing according to the first RAT comprising decoding SL control information (SCI) according to the first RAT, wherein the first RAT is long term evolution (LTE) and the second RAT is new radio (NR);
based on the SL sensing according to the first RAT, select resources for SL transmissions according to the second RAT based on a scheduling unit of the first RAT, the scheduling unit of the first RAT being a subframe and having a dimension at least twice a dimension of a scheduling unit of the second RAT, the scheduling unit of the second RAT being a slot, wherein scheduling units of the second RAT in a first part of the scheduling units of the first RAT have priority for selection; and
perform SL transmission according to the second RAT using the selected resources.
